(19) United States
(12) Patent Application Publication
(10) Pub. No.: US 2010/0271212 A1
(43) Pub. Date: Oct. 28, 2010

(54) DEVICE AND APPARATUS FOR DETECTING BODILY FLUIDS

(75) Inventor: Anthony Edward Page, Nelson (NZ)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignees: Robin WHALLEY, Nelson (NZ); Paul Donald LE GROS, Nelson (NZ)

(21) Appl. No.: 12/746,893

(22) PCT Filed: Dec. 12, 2008
(86) PCT No.: PCT/NZ2008/000331

§ 371 Date: Jun. 8, 2010

(30) Foreign Application Priority Data
Dec. 12, 2007 (NZ) NZ 564273

(51) Int. Cl. G08B 23/00

(52) U.S. Cl. 340/573.1

(57) ABSTRACT

This invention relates to a device for use in detecting and monitoring bodily fluids, the device includes electrodes configured and arranged to be electrically connected to respective conductive element connector means, the conductive element connector means being adapted to be electrically connectable to a moisture sensing means in the form of conductive elements being provided on or in a textile material, and wherein the conductive elements are of a electrically separated distance such that, in use, when an amount of moisture or fluid is present on or in the textile material between the conductive elements, an electrical closed circuit is formed between the conductive elements causing the electrodes to change state from being electrically open to being electrically closed.

### TECHNICAL FIELD

This invention relates to devices and apparatus for detecting and monitoring bodily fluids. More particularly, but not exclusively, the invention relates to a device and apparatus for detecting blood leak during dialysis in response to such detection.

### BACKGROUND ART

The detection of bodily fluids in some circumstances can be important to the well-being of a person. For example, early detection of any leakage of blood around the site of insertion of a dialyzing needle during dialysis treatment, in particular nocturnal dialysis, can be useful. Another example would be the detection of blood from the site of a skin ulcer, or exudate from a wound.

Currently there are very few specialised detecting apparatus available for the detection of blood leak during dialysis. Some clinics or hospitals use nocturnal enuresis (bedwetting) treatment alarms. While these alarms may be triggered by blood leak, they do not have a sensor or attachment means that has been specifically designed for this purpose. The sensor has to be taped into place over the fistula site. The site of the fistulas into which the dialysis needles are used can be very sensitive, and a taped sensor in place is likely to cause discomfort to a patient.

It is a non-limiting object of the invention to provide a device for use in monitoring bodily fluids which overcomes at least some of the abovementioned problems, or at least to provide the public with a useful choice.

### SUMMARY OF THE INVENTION

According to a first broad aspect of the invention there is provided a device for use in detecting and monitoring bodily fluids, the device includes electrodes configured and arranged to be electrically connected to respective conductive element connector means, the conductive element connector means being adapted to be electrically connectable to spaced apart conductive elements being formed on or in a textile material, and wherein the conductive elements are of a predetermined spaced apart distance such that, in use, when an amount of moisture or fluid is present on or in the textile material between the conductive elements, an electrical closed circuit is formed between the conductive elements causing the electrodes to change state from being electrically open to being electrically closed.

Preferably the electrodes are mounted or formed in a base plate, and the conductive element connector means includes conductive ribs adapted to connect, in use, to the conductive elements.

Desirably a hinged clip is formed adjacent one edge of the base plate to enable, in use, the clip to close about the hinge to retain and electrically connect the conductive ribs to respective said conductive elements located on or in the textile material.

Preferably the base plate is formed of an electrically insulating material, and wherein the electrodes are formed of a conductive plastics material.

Desirably the electrodes are formed of a conductive plastics material overmoulded over the base plate formed of a non-conductive thermoplastics material.

Optionally a protruding conductive rib is electrically connected to each electrode and formed on the base plate, the conductive ribs are positioned in a spaced apart orientation, in use, to releasably connect to respective spaced apart conductive elements.

Preferably a hinged clip is formed adjacent one edge of the base plate, and wherein rib receiving slots are aligned in respective opposing positions in the opposing face on the clip to enable, in use, the clip to close about the hinge such that the slots receive respective said conductive ribs and the clip locks in a closed position against the base plate to retain and electrically connect the conductive ribs to respective said conductive elements located on or in the textile material.

Advantageously an electrical socket is formed in electrical contact with the electrodes, the electrical socket being adapted to releasably receive an electrical plug that is electrically connectable to a moisture alarm means.

Optionally the device further comprises a signal processing means that generates an output activation signal when the conductive elements form a closed circuit, and wherein a transmitter means is associated with the signal processing means to transmit the activation signal to a signal receiving means to trigger an alarm means. Optionally the signal processing means is electrically connectable to the electrical socket.

Preferably the conductive elements are formed on or in a woven or non woven textile material as conductive threads or conductive yarns.

Desirably the conductive elements are conductive threads or conductive yarns formed on or in hydrophilic moisture absorbing textile material.

In one preferred embodiment of the invention the conductive elements are conductive yarns formed on or in a strip of material forming a strap, and wherein the conductive yarns are in a spaced apart substantially parallel arrangement along the length of the strip of material.

In one non-limiting embodiment of the invention, the device can include conductive yarns that can be spaced apart about between about 10 mm to 40 mm. It will be appreciated that these dimensions are provided as non limiting examples and that any suitable distance between two conductive yarns can be provided in accordance with the invention.

Optionally the strip of material is of a sufficient length to loop about the limb of a user so that two points along each conductive yarn contact with respective said conductive element connector means.

Desirably the conductive elements are conductive threads or conductive yarns formed on or in a flexible textile material, the material being a non woven material made of cellulose acetate.

According to a second broad aspect of the invention there is provided a moisture detecting apparatus including the moisture detecting device in accordance with the first aspect of the invention, and further including a moisture alarm means being electrically connectable to the electrodes or to an electrical socket formed in electrical contact with the electrodes, the electrical socket being adapted to releasably receive an electrical plug that is connected to the moisture alarm means.

### BRIEF DESCRIPTION OF THE DRAWINGS

Preferred and alternative embodiments of the invention will now be described and illustrated, by way of example only, with reference to the accompanying drawings in which:

FIG. 1: Shows a bottom view of the device 1 in an open position according to one embodiment of the invention;

FIG. 2: Shows a side view of the device 1;

FIG. 3: Shows a perspective view of the device 1 in an open position;

FIG. 4: Shows a bottom view of the device 1 in a closed or folded position;

FIG. 5: Shows a top view of the device 1 in a closed or folded position;

FIG. 6: Shows a view of the plastic over-moulded electrodes connected to an electrical connector and associated plug;

FIG. 7: Shows a view of the plastic over-moulded electrodes and connecting surfaces of the device 1;

FIG. 8: Shows a detailed view of the plastic over-moulded electrodes on an insulating surface;

FIG. 9: Shows a view of the device 1 in an open position with a textile-based material 2 in place for connecting thereto;

FIG. 10: Shows a view of the device 1 in a partially closed position with a textile-based material 2 in place for connecting thereto;

FIG. 11: Shows a view of the device 1 in a closed position with a textile-based material 2 in place and electrically connected thereto;

FIG. 12: Shows a view of the textile-based material 2 formed into a loop and about to be secured to the device 1;

FIG. 13: Shows a simplified schematic view of a textile-based material provided with conductive yarns onto which a moisture detecting device 50 is connectable to the yarns; and

FIG. 14: Shows a simplified schematic view of a textile-based material provided with conductive yarns onto which a moisture detecting apparatus 60 is connectable thereto.

### DETAILED DESCRIPTION OF THE DRAWINGS

Referring to the figures, a moisture detecting device, generally referred to as 1, according to a preferred embodiment of the invention, is illustrated.

The moisture detecting device 1 is, inter alia, configured and arranged for use in detecting and monitoring fluids, and in this respect includes a moisture sensing means advantageously in the form of a textile material preferably provided with at least two conductive elements 3. In this respect it is seen that the device 1 is adapted to be electrically connected to a moisture or fluid sensing means.

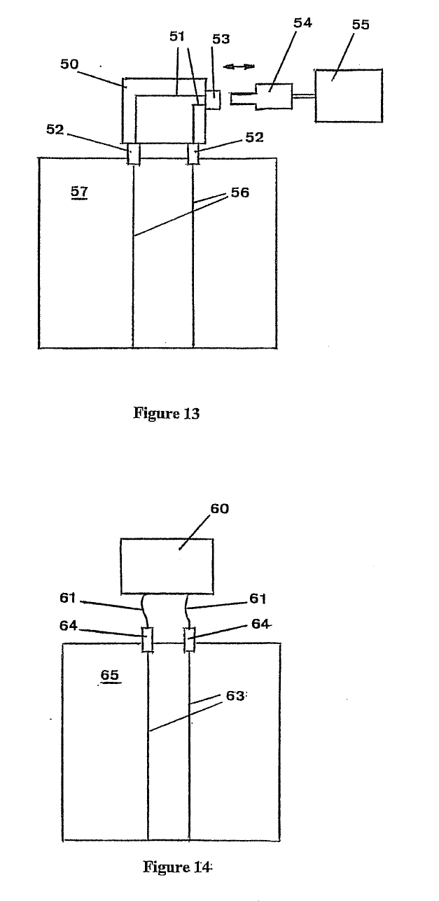

The moisture sensing means can be provided in a textile material 57 formed as part of an item of clothing or formed as a pad 65, as seen more clearly as in FIGS. 13 and 14. In applications where the sensing means is provided in or as part of an item of clothing by way of embroidered conductive elements preferably in the form of conductive threads or yarns, examples include underwear, vests, nightwear, bed linen, or the like.

The device 1 can be attachable to conductive elements located on a large fabric sensing means in the form of a cloth or pad 57, as seen more clearly in FIG. 13, that is placable under a user after an event such as an operation, childbirth, or for a variety of medical conditions such as for example, ulcers, where there is a risk of blood loss for which a medical professional monitoring a patient's state would want to be alerted to such blood loss.

For ease of description in this specification, references herein to a strap 2 will also include broader references to other forms of sensing means that include textile pads and sheets of various sizes as desired, various lengths of bandages as required and suitable, or items of clothing incorporating the conductive elements, yarns, or threads embroidered or formed in or removably attachable to the textile material.

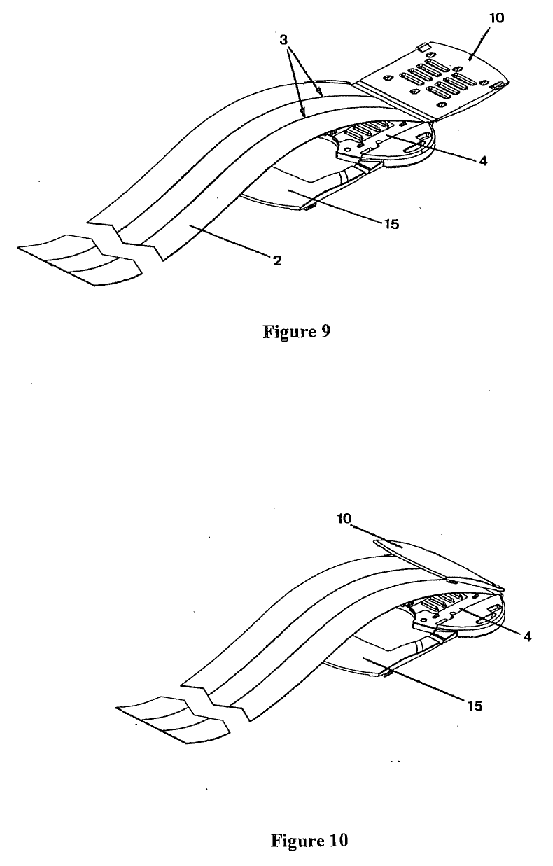

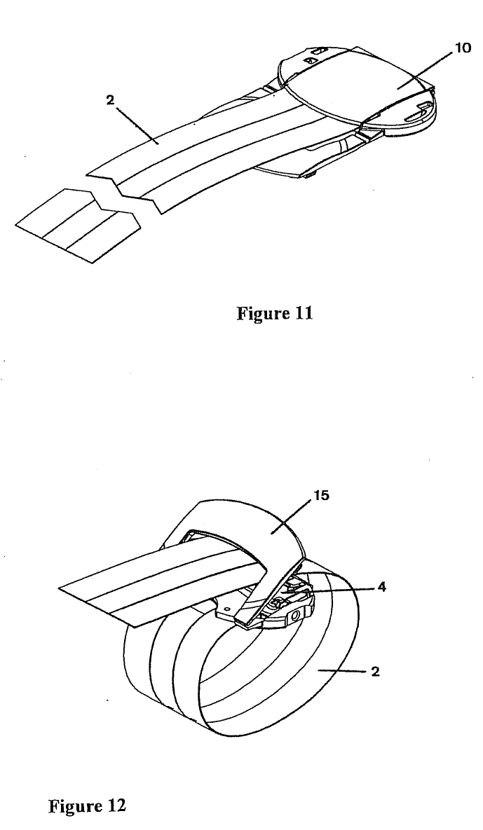

In one non-limiting example of the invention as an example only with reference to FIGS. 9 to 12, the moisture sensing means can include a strap 2 that is locatable about the limb of an animal or human or a strip of strap can be adhered to the skin of a human or animal in a place where any undue or excessive amounts of bodily fluid should not be present, and if so it may be a symptom of a medical complication or a hazardous state of health or condition.

Desirably the moisture or fluid conducting material is in the form of a textile-based material 2 as illustrated in FIGS. 9 to 12. The device 1 is preferably adapted to provide a method or means for adjusting the circumference or length of the material 2 to fit about the limb of a user to enable, in use, suitable contact with the skin of a user for moisture or fluid detection purposes.

The material 2, in one non-limiting application of the invention, is advantageously in the form of a strap and is of a suitable length allowing the material to fit about a limb of a user. It can also be of a suitable width to cover the fistula whilst still allowing dialysis staff to be able to observe and monitor the area around the fistula. In this application a desirable width may be about 40 millimetres, although in other applications it is seen that the width could vary greatly from being significantly narrower, such as when used as a blood leak device for monitoring an ulcer, or be much wider to about 1 metre or more in applications where larger amounts of fluid could be present.

The material 2 can optionally and desirably be of a non-woven type, and may desirably be formed from any hydrophilic moisture absorbing material. One example of a suitable material is a flexible non-woven textile material made of cellulose acetate, although it is envisaged that any material with a moisture absorbing capacity and being suitable to serve as a moisture trigger may be employed as a strap 2 within the scope of the invention. Alternatively the material 2 may be a woven cotton fabric or similar.

In one non-limiting medical application of the present invention, the strap material 2 is secured and wrapped about the arm of a user undergoing dialysis, with the strap 2 covering the site where a needle enters the fistula so that any blood leaking onto the skin will be absorbed by the hydrophilic material of the strap 2 and may serve as a trigger to the presence of a leak. Another example of use is for a patient requiring monitoring for any blood seepage or leaks from the site of a wound from an injury or from an incision from surgery. Early detection of such blood leakage may be important for some patients, and most certainly would be critical for patients suffering from haemophilia.

Yet another example of an application of the invention is in the detection of higher levels of perspiration as may happen when a diabetic suffers hypoglycemia due to an impending insulin coma. It is envisaged that any application whereby the presence of bodily fluid or moisture should be detected could be included in the uses of the present invention.

The strap 2, as clearly seen in FIGS. 9 to 12, preferably includes at least two spaced apart conductive elements 3. The conductive elements 3 are desirably at least two flexible electrical conduits or conductive strips that may be formed in parallel to the other or be provided at varying distances. One example of a preferred conductive element 3 is in the form of embroidered conductive yarns. In this embodiment, an automated sewing process can be employed to construct or fabricate the conductive yarns or elements 3 on the strap 2. The elements 3 are desirably formed of any one or more of the following material being metal fibres, carbon fibres, metallized polymer fibres, and/or conductive polymer coated fibres or any other conductive fibre and the like, or otherwise such as conductive wires or even conductive strips that are adhered onto material or clothing.

The distance between the conductive elements or yarns 3 is not fixed and can vary depending on the application. The elements or yarns 3 can be spaced apart at about 10 to 15 mm or less when rapid monitoring and detection of a small amount of moisture is required, or the distance set much wider than 10 to 15 mm when a user wants to avoid false triggering of an alarm or alert means when a small amount of moisture is present.

In one laboratory example where the conductive elements 3 are approximately 10 to 15 mm apart, activation of an alarm or alert signal has been triggered within a time period of 1 to 2 seconds when a relatively small amount of blood, being 1 milliliters or less, is introduced between two conductive elements 3.

The strap 2 when dry serves as an open electrical circuit and insulator between the two conductive elements 3, and are effectively insulated from the other when in an open state. The material of the strap 2 serves to maintain a predetermined distance between the conductive elements 3. It is seen that a closed electrical circuit can form between the two or more conductive elements 3 when fluid such as blood is absorbed by the strap 2.

The strap 2 is advantageously used in conjunction with the device 1 of the invention whereby the device 1 provides a form of interface between the moisture detecting means and the alarm or alert triggering and processing means, the electrical circuitry receiving and processing the trigger signal is not shown but can be any form of suitable electronic circuitry such as an alarm means or otherwise triggered by a closed electrical circuit or switch.

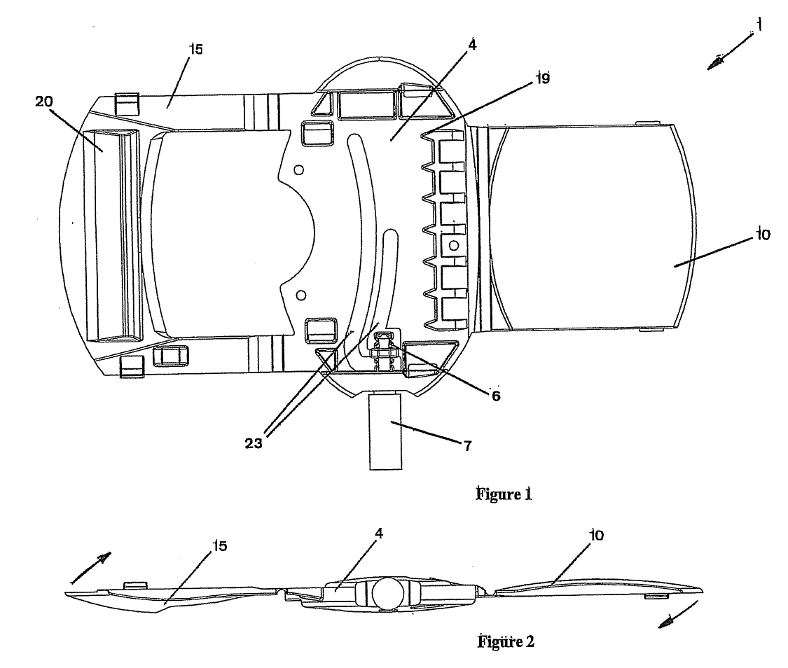

The device 1 advantageously includes a base plate 4 configured and arranged to retain a removably attachable strap 2 and be electrically connected thereto by way of a conductive element connector means. The base plate 4 is desirably a substantially planar surface formed of any suitable durable and resilient material, and desirably is formed of a non conductive or insulating plastics material such as a non conductive thermoplastics material. Advantageously the base plate 4 is provided with at least two conductive strips 23 therein connecting two spaced apart protruding electrodes in the form of conductive ribs 5 to an electrical connector desirably in the form of an electrical socket 6, as more clearly seen in FIGS. 1 and 6. The strips 23 effectively form an electrical connection between at least two spaced apart conductive elements 3 and the electrical socket 6. The socket is desirably moulded to receive an electrical plug 7, for example a 2.5 mm mono plug, or other such connector means configured to transfer a signal to an external alarm means (not shown). The external alarms means will be of any known and readily available type as will be appreciated by one skilled in the art, and the alarm means is configured and arranged to emit an audible alarm and/or visual indicator such as an LED or other light to alert a person to the activation of a closed electrical circuit condition indicating the presence of moisture or fluid at the monitoring site.

It is envisaged that in an alternative embodiment of the invention, the device 1 may optionally be adapted with a transmitter means and a suitable power source to transfer an activation signal to a remote receiver means and associated alarm means in the event of current flowing across or between the conductive ribs 5.

It is seen that the ribs 5 are preferably made of a conductive plastics material that are advantageously overmoulded with a suitable non conductive thermoplastics material forming a portion of the base plate 4 or be set flush with the base plate 4.

The ribs 5 are desirably formed as protruding elements from electrically separated or spaced apart conductive pads 8 to enable, in use, the conductive ribs 5 to electrically contact and apply and maintain contact pressure on the conductive yarns, threads or elements 3 to form an electrical contact and represent the conductive element connector means. This pressure can be exerted by way of a first hinged clip means desirably in the form of a clip 10 provided with a hinge 11 that can be pivoted to a closed position, in use, such that opposing rib receiving slots or indentations 12 close over corresponding ribs 5 securing the conductive elements 3 therebetween. The clip 10 can include a latch means optionally in the form of latching lugs 9 that interlink with opposing catches 13 configured and arranged such that, in use, when the clip 10 is closed, the lugs 9 latch or lock into opposing catches 13 to secure the conductive elements 3 of the strap 2 to the electrodes or ribs 5.

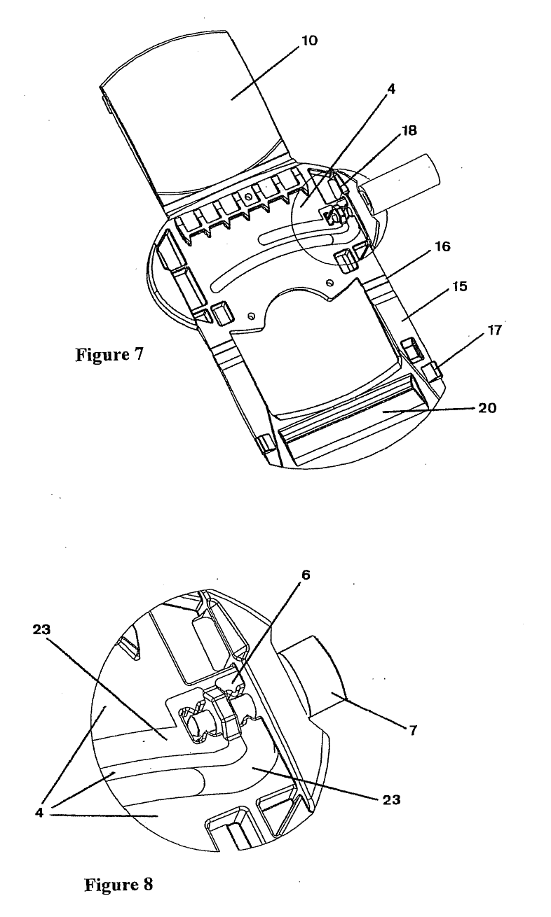

Referring now more particularly to FIG. 7, a second hinged clip, generally referred to as 15, is configured and arranged to secure the strap 2 in the device 1, and is particularly suitable for securing the strap 2 about a limb of a user in a method as seen in the steps of a method of assembly of FIGS. 9 to 12.

The second clip 15 desirably includes a hinge 16 for pivotably closing the clip 15 against the base plate 4 when securing the strap 2 in the shape of a wrap or loop being secured about the arm of a user. FIG. 12 shows the other end of the strap 2 being secured by the clip 15 closing onto the strap 2 passing through over the base plate 4.

The clip 15 advantageously includes a latch means optionally in the form of latching lugs 17 that interlink with opposing catches 18 configured and arranged such that, in use, when the clip 15 is closed, the lugs 17 latch or lock into opposing catches 18 to secure the strap 2 to the base plate 4.

The strap 2 can be secured to the base plate 3 by use of strap securing means desirably in the form of an array of protruding pins 19 that, in use, press the strap 2 into the opposing concave rebate 20 in the clip 15. This form of strap securing means is considered effective to retain the strap 2 at a preferred length about the limb of a user, the form of the strap 2 secured as a loop in and about the device 1 is seen clearly in FIG. 12.

It is also seen that when the clip 15 has been snap closed with the strap 2 being pressed into the protruding pins 19, the strap 2 is secured in the device 1. However, due to the configuration of the pins 19, the strap 2 can advantageously be tightened by simply pulling the strap 2 tighter, and the pins 19 will prevent the strap 2 from releasing. If the strap 2 must be adjusted to provide more slack, a user can release the clip 15 from the base plate 4 and adjust the position of the strap 2 or feed out the strap 2 as required, and then the clip 15 is refastened to re-secure the strap 2.

Referring now to FIG. 13, a moisture detecting device, generally referred to as 50, according to a second preferred embodiment of the invention, is illustrated.

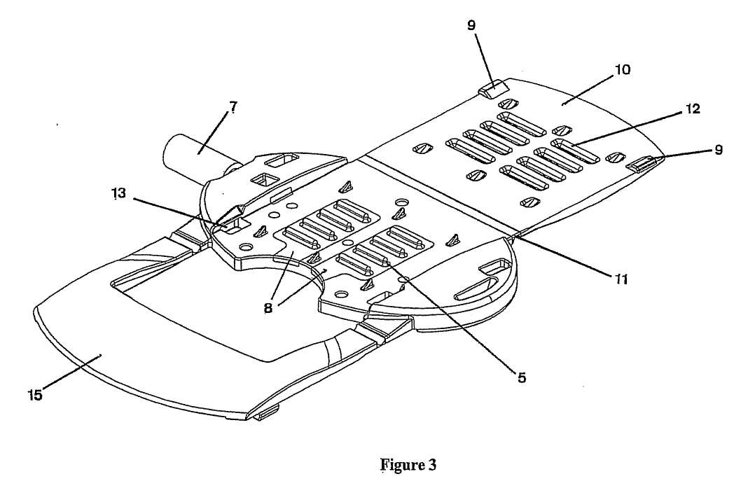

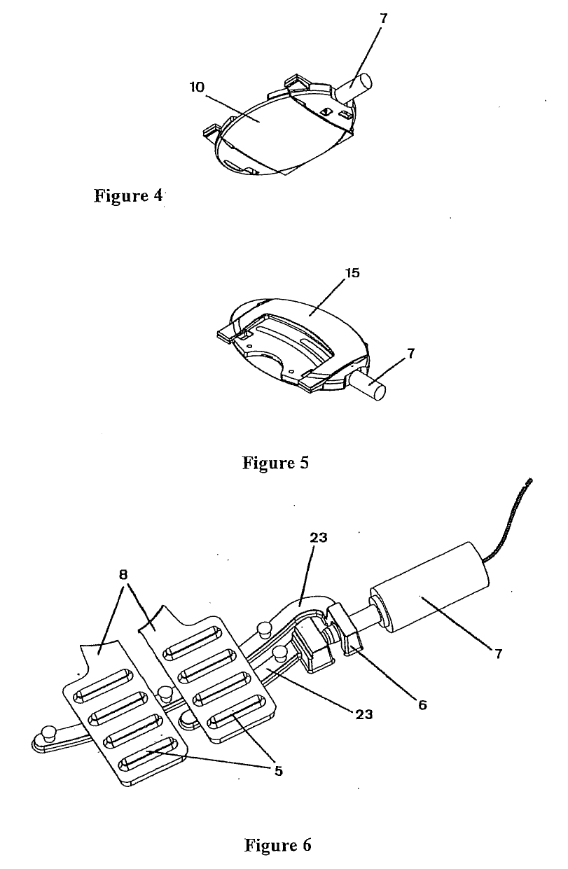

The device 50 is seen to be similar to the device 1 of FIGS. 1 to 8, although a more simplified version is illustrated in this embodiment.

The device 50 includes electrodes 51 configured and arranged to be electrically connected to respective conductive element connector means 52. In its passive state, the electrodes and connector means 52 are in an electrically open state. The electrodes 51 are connected to a socket 53 into which a plug 54 can be releasably connected. The plug 54 is connected to an alarm or alert indicator means 55. The device 1 is electrically connectable to conductive elements 56 provided in or on a textile material 57. The textile material 57 may be any suitable size given the particular application, and the material 57 may be considered a sensing pad that is placable in any location to detect moisture or fluid.

It will also be appreciated that the conductive elements 56, while following a varying or parallel pattern but always in an electrically separated or open state when the textile is dry, can be embroidered in any curved or zig zag pattern on the material 57 as required or desired. It will be seen that, in operation, and when the socket connects the device 1 to an alarm or alert indicator means 55, the presence of sufficient fluid or moisture electrically connecting the electrodes 56 to being in an electrically closed state, will trigger the alarm means 55.

Alternatively instead of the alarm means 55 being connected by a plug 54 into the device 50, the device 50 may be provided with a signal processing means and an RF transmitter that can generate an output indicator signal that is transmitted to a receiver means in the alarm means 55 for activation purposes. It will be appreciated that such devices can be incorporated into the device 50 of the invention if desired.

Referring now to FIG. 14, a moisture detecting apparatus, generally referred to as 60, according to a third preferred embodiment of the invention, is illustrated.

The apparatus 60 includes all of the main components of the device 1 or the device 50, although instead of an electrical socket being provided to connect the device to an external or remote alarm means, the alarm means is integrated into the casing of the apparatus 60. In this respect it is seen that electrodes 61 are attachable to conductive elements 63 in a textile pad or material 65 by the electrodes clipping to respective elements 64. The apparatus 60 includes a compact moisture sensing device and wherein an alarm means is configured and arranged within the casing with a signal processing means adapted and configured to generate an alarm signal that emits an audible and/or visual alarm to alert a user to the apparatus 60 detecting the presence of moisture or fluid.

It will be appreciated that in an alternative embodiment of the invention the device 1 may operate with any area of cross section of the strap 2 being retained in the clip 10 and wherein the strap 2 can be adhered to the skin of a user or placed in a position to serve as a moisture sensing means. In this respect one side of the strap 2 may include a tacky adhesive means suitable for adhering to the skin. Any known form of adhesive compounds used for plasters and for bandages and the like may be applied to the strap 2. Furthermore, bandages may be provided with conductive threads and be used as a sensing means for use with the device 1. Another example of an application is whereby the device 1 is clipped to the waistband of underwear, and whereby the device 1 is attached to a sensing pad attachable to the outer or inner side of such underwear in a suitable location. Alternatively the conductive elements 3 are desirably in the form of conductive threads stitched or embroidered into the underwear or item of clothing.

Wherein the aforegoing reference has been made to integers or components having known equivalents, then such equivalents are herein incorporated as if individually set forth. Accordingly, it will be appreciated that changes may be made to the above described embodiments of the invention without departing from the principles taught herein.

It is to be understood that the above description is intended to be illustrative, and not restrictive. Additional advantages of the present invention will become apparent for those skilled in the art after considering the principles in particular form as discussed and illustrated. Thus, it will be understood that the invention is not limited to the particular embodiments described or illustrated, but is intended to cover all alterations or modifications which are within the scope of the appended claims.

1-20. (canceled)

21. A device for use in detecting and monitoring bodily fluids, the device includes electrodes configured and arranged to be connected to respective conductive element connector means formed adjacent the electrodes, the electrodes also being formed into an electrical socket adjacent one end, the electrodes being made of a conductive material moulded in a base plate, the base plate being formed of a electrically insulating non-conductive material, the conductive element connector means being adapted to be electrically connectable to conductive elements being provided on or in a textile material, and wherein the conductive elements are of a electrically separated distance such that, in use, when an amount of moisture or fluid is present on or in the textile material to electrically bridge the gap between the conductive elements, an electrical closed circuit is formed between the conductive elements causing the electrodes to change state from being electrically open to being electrically closed.

22. A device in accordance with claim 1 wherein the conductive element connector means includes conductive ribs adapted to releasably connect, in use, to the conductive elements.

23. A device in accordance with claim 2 wherein a hinged clip is formed adjacent one edge of the base plate to enable, in use, the clip to close about the hinge to retain and electrically connect the conductive ribs to respective said conductive elements located on or in the textile material.

24. A device in accordance with claim 21 wherein the electrodes are formed of a conductive plastics material overmoulded over the base plate, the base plate being formed of a non conductive thermoplastics material.

25. A device in accordance with claim 24 wherein a protruding conductive rib is electrically connected to each electrode and formed on the base plate, the conductive ribs are positioned in a spaced apart orientation, in use, to releasably connect to respective spaced apart conductive elements.

26. A device in accordance with claim 25 wherein a hinged clip is formed adjacent one edge of the base plate, and wherein rib receiving slots are aligned in respective opposing positions in the opposing face on the clip to enable, in use, the clip to close about the hinge such that the slots receive respective said conductive ribs and the clip locks in a closed position against the base plate to retain and electrically connect the conductive ribs to respective said conductive elements located on or in the textile material.

27. A device in accordance with claim 21 wherein the electrical socket is adapted to releasably receive an electrical plug that is electrically connectable to a moisture alarm means.

28. A device in accordance with claim 27 further comprising a signal processing means that generates an output activation signal when the conductive elements form a closed circuit, and wherein a transmitter means is associated with the signal processing means to transmit the activation signal to a signal receiving means to trigger an alarm means.

29. A device in accordance with claim 28 wherein the signal processing means is electrically connectable to the electrical socket.

30. A device in accordance with claim 28 wherein the conductive elements are formed on or in a woven or non woven textile material as conductive yarns.

31. A device in accordance with claim 21 wherein the conductive elements are formed on or in a woven or non woven textile material as conductive yarns.

32. A device in accordance with claim 21 wherein the conductive elements are conductive yarns formed on or in hydrophilic moisture absorbing textile material.

33. A device in accordance with claim 21 wherein the conductive elements are conductive yarns formed on or in a strip of material forming a strap, and wherein the conductive yarns are in a spaced apart substantially parallel arrangement along the length of the strip of material.

34. A device in accordance with claim 33 wherein the conductive yarns are spaced apart between about 10 mm to 40 mm.

35. A device in accordance with claim 33 wherein the strip of material is of a sufficient length to loop about the limb of a user so that two points along each conductive yarn contacts with respective said conductive element connector means.

36. A device in accordance with claim 21 wherein the conductive elements are conductive yarns formed on or in a flexible textile material, the material being a non woven material made of cellulose acetate.

37. A moisture detecting apparatus for use in detecting and monitoring bodily fluids, the apparatus including the device of claim 21, and further including an alarm means being electrically connectable to the electrodes or to an electrical socket formed in electrical contact with the electrodes, the electrical socket being adapted to receive an electrical plug that is connectable to the alarm means.
